(19) United States
(12) Patent Application Publication
(10) Pub. No.: US 2025/0261239 A1
(43) Pub. Date: Aug. 14, 2025

(54) MULTI TRANSMISSION POINT OPERATION FOLLOWING RANDOM ACCESS IN A WIRELESS COMMUNICATION SYSTEM

(71) Applicant: Telefonaktiebolaget LM Ericsson (publ), Stockholm (SE)

(72) Inventors: Igor Moaco GUERREIRO, FORTALEZA (BR); Carlos FILIPE MOREIRA E SILVA, FORTALEZA (BR)

(73) Assignee: Telefonaktiebolaget LM Ericsson (publ), Stockholm (SE)

(21) Appl. No.: 18/706,974

(22) PCT Filed: Nov. 5, 2021
(86) PCT No.: PCT/EP2021/080703

§ 371 Date: May 2, 2024

(51) Int. Cl. H04W 74/0833; H04W 24/10; H04W 56/00

(52) U.S. Cl. CPC H04W 74/0833; H04W 24/10; H04W 56/001

(57) ABSTRACT

A method for performing initial access by a wireless device (130) in a wireless communication system (300), where the communication system comprises two or more transmission points, TRP, (110, 120) connected to a clustering entity (160), the method comprising, receiving synchronization signals by the wireless device (130), where each synchronization signal originates from a respective TRP (110, 120), transmitting respective random access signals from the wireless device (130) to the TRPs (110, 120) in response to the received synchronization signals, where each random access signal is associated with a random access signal identification, measuring respective signal qualities of the random access signals received at the TRPs (110, 120), and associating each signal quality measurement with a respective random access signal identification, communicating the measured signal qualities with corresponding random access signal identifications from the TRPs to the clustering entity (160), communicating data indicative of random access signal identifications associated with the plurality of random access signals transmitted by the wireless device (130), from the wireless device (130) to the clustering entity (160), constructing a dataset at the clustering entity (160) comprising measured signal qualities with corresponding TRPs (110, 120) and wireless devices (130), based on the random access signal identifications received from the TRPs and on matching random access signal identifications received from the wireless device (130), where the dataset is configured to support cluster formation of the TRPs for communicating with a wireless device using multi-TRP operation.

### TECHNICAL FIELD

The present disclosure relates to techniques for performing random access in a wireless communication system implementing multi transmission point (TRP) operation. There are disclosed methods, devices, and network nodes arranged to support in data collection which facilitates TRP clustering for multi-TRP operation.

### BACKGROUND

A cellular access network is a network of access points or radio base stations which provide wireless access to wireless devices over a coverage area.

Modern cellular access networks may communicate with a wireless device using more than one transmission point (TRP) at the same time, a mode of operation commonly referred to as multi-TRP transmission. Multi-TRP transmission may improve both spectral efficiency, throughput and robustness of the communication between wireless devices and the access network.

In a third generation partnership program (3GPP) defined network such as a fifth generation (5G) access network, a 5G node B (gNodeB or gNB) can be connected to multiple spatially distributed TRPs, and the communication may also involve more than one gNB. Intra- or inter-cell clusters of TRPs and/or gNBs can be formed for communicating with a given wireless device. Coordinated multi-point transmission may be realized in either a coherent or a noncoherent fashion, with respective advantages and disadvantages, as discussed by Jin Liu et. al. in “Initial Access, Mobility, and User-Centric Multi-Beam Operation in 5G New Radio,” IEEE Communications Magazine, vol. 56, no. 3, pp. 35-41, March 2018.

Multi-TRP transmission relies on the formation of clusters of TRPs, sometimes referred to as coordination clusters, where a coordination cluster basically identifies which TRPs out of a set of available TRPs in the network that are to be used in communicating with a given wireless device. A coordination cluster can be formed either statically, e.g., as a fixed collection of TRPs based on the network topology, or dynamically based on current radio propagation channel realizations. Statically formed clusters are often sub-optimal in terms of communication performance since changes in radio propagation conditions are not accounted for. However, a static configuration of coordination clusters also involves very little communication and processing overhead, which is an advantage. Coordination clusters may of course also be statically initialized, and then dynamically adapted to account for the current radio propagation channel conditions.

To improve the benefits of a multi-TRP transmission network, wireless device centric coordination clusters of TRPs can be formed in a dynamic fashion, where the current radio propagation channel realizations from a given wireless device to the set of available TRPs are accounted for in the formation of the TRP cluster. This type of dynamic cluster formation is then done after the initial access procedure, where the wireless device connects to the network, which is a drawback, since there may be a delay from the time a wireless device connects to the wireless network until multi-TRP communication is enabled. There is a general desire to reduce the cluster formation time, and of course also to limit the communication overhead incurred during cluster formation.

### SUMMARY

It is an object of the present disclosure to provide techniques for improved cluster formation in wireless communication systems. This object is at least in part obtained by a method for performing initial access by a wireless device in a wireless communication system. The communication system comprises two or more transmission points (TRP) connected to a clustering entity, such as a central processing node or distributed network function. The method comprises receiving synchronization signals by the wireless device, where each synchronization signal originates from a respective TRP, and transmitting respective random access signals from the wireless device to the TRPs in response to the received synchronization signals, where each random access signal is associated with a random access signal identification. The method also comprises measuring respective signal qualities of the random access signals received at the TRPs and associating each signal quality measurement with a respective random access signal identification. The method further comprises communicating the measured signal qualities with corresponding random access signal identifications from the TRPs to the clustering entity, communicating data indicative of random access signal identifications associated with the plurality of random access signals transmitted by the wireless device, from the wireless device to the clustering entity, and also constructing a dataset at the clustering entity comprising measured signal qualities with corresponding TRPs and wireless devices, based on the random access signal identifications received from the TRPs and on matching random access signal identifications received from the wireless device, where the dataset is configured to support cluster formation of the TRPs for communicating with a wireless device using multi-TRP operation.

This way an initial cluster formation can be determined based on the constructed dataset already as part of the random access procedure, which is the first step that is performed when a wireless device powers up and wishes to connect to the wireless communication system. The initial cluster formation is performed faster in this way. By reducing the delay in cluster formation, the benefit of clustering becomes available sooner in the communication procedure, which is especially beneficial for short duration communication sessions.

According to aspects, the synchronization signals comprise synchronization signal blocks (SSB) in a third generation partnership (3GPP) defined wireless communication system. 3GPP systems are important and widespread wireless communication systems. It is an advantage that the herein proposed techniques are suitable for use in such wireless communication systems. Also, recent 3GPP networks support Internet of Things (IoT) applications which wake up and generates small bursts of data, before going back to sleep. Legacy cluster formation methods may not complete fast enough to be of benefit to these and similar applications.

As will be discussed in more detail below, the random access signal identification may comprise a random access radio network temporary identity (RA-RNTI). As will be explained in more detail below, this option is relatively light in terms of signalling load and energy consumption since the UE can detect only one random access response (RAR) and attach its list of RA-RNTIs in the subsequent messaging, i.e., in the transmission of the MSG3. However, this may lead to ambiguity which then needs to be resolved in further steps. The ambiguity situation can be improved if the random access signal identification comprises a temporary cell radio network temporary identity (TC-RNTI) or a combination of RA-RNTI and a Random Access Preamble Identifier (RAPID). If the TC-RNTI is included, then no ambiguity will be observed in the same-RACH-occasion-but-different-preambles case, but the UE may need to detect multiple RARs and choose one out of them. For the RA-RNTI and RAPID combination, no ambiguity will be observed in the same-RACH-occasion-but-different-preambles case, but the UE needs to report more information, i.e., a list of (RA-RNTI, RAPID) pairs.

The signal quality measurement may, for instance, comprise a received signal strength, a binary indication of successful reception, a measure of radio propagation channel delay or angle and/or a measure of radio propagation channel dispersion and/or angle of arrival information. Combinations of signal quality measures can also be used with advantage. Thus, the herein disclosed methods are versatile in that they can be used with a wide variety of different signal quality metrics.

The methods may comprise transmitting a radio resource control (RRC) setup request from the wireless device, corresponding to at least two of the transmitted random access signals. This is a robust and relatively efficient way or the UE to partake in the procedure, since the RRC setup request is anyway transmitted.

Constructing the dataset at the clustering entity optionally comprises identifying a subset of random access signal identifications received from the TRPs as belonging to a single wireless device, based on the data indicative of random access signal identifications associated with random access signals transmitted by the wireless device. For instance, the constructing may comprise identifying a set of RA-RNTI which is associated with the wireless device. This way a mapping between signal quality measure and wireless device identity can be obtained in an efficient and reliable manner. The dataset optionally comprises tuples of physical cell ID (PCI) SSB identifier, and wireless device ID with corresponding signal quality measurement. A wireless device may also be identified by its cell radio network temporary identifier (C-RNTI) if this is readily available.

The method may also comprise initially broadcasting a multi-TRP transmission indication from the TRPs, to inform devices that multi-TRP operation is an option in the wireless communication system.

The above advantages are also obtained by a wireless device, by a transmission point, and by a clustering entity. There are also disclosed herein computer programs a computer program products associated with the above-mentioned advantages.

### BRIEF DESCRIPTION OF THE DRAWINGS

The present disclosure will now be described in more detail with reference to the appended drawings, where:

FIG. 1 shows aspects of an example communication system according to prior art;

FIG. 2 is a signaling diagram illustrating random access procedures;

FIG. 3 shows aspects of an example communication system;

FIG. 4 is a signaling diagram illustrating random access procedures;

FIG. 5 is a flow chart illustrating an example method according to the present disclosure;

FIG. 6 shows random access signaling in a wireless communication system;

FIG. 7 schematically illustrates example datasets and UE reports;

FIGS. 8A-B show an example ambiguity situation with example resolution;

FIGS. 9-10 schematically illustrate further example datasets and reports;

FIG. 11 is a flow chart which summarizes methods according to the present disclosure;

FIG. 12 schematically illustrates processing circuitry; and

FIG. 13 shows a computer program product.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

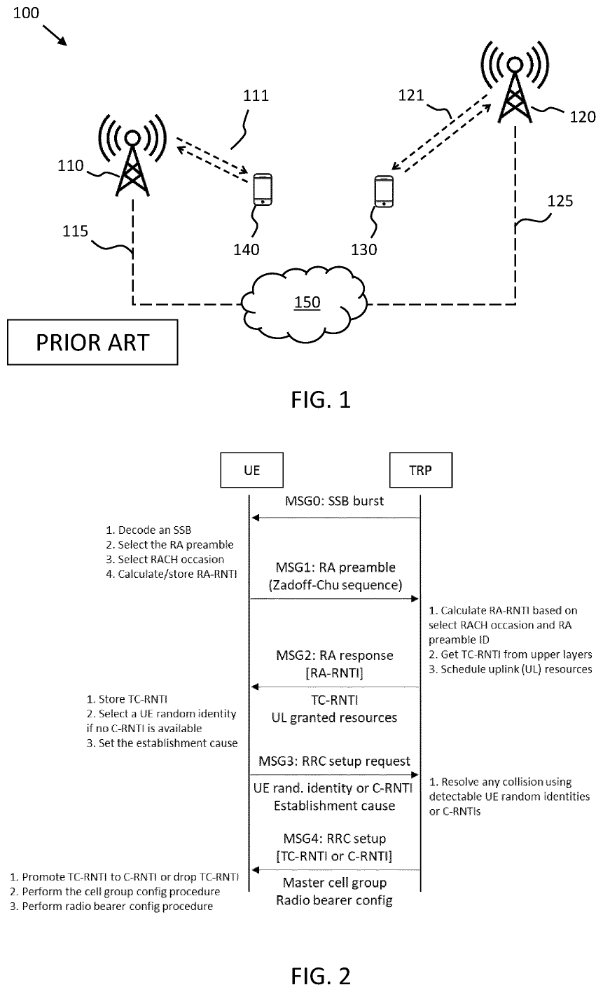

FIG. 1 illustrates an example communication system 100 according to prior art, where transmission points (TRP) 110, 120 provide wireless network access to wireless devices 130, 140, also known as user equipment (UE), over a coverage area. The terms wireless device and UE will be used interchangeably herein. The TRPs may be connected to one or more radio base stations. A radio base station in a fourth generation (4G) third generation partnership program (3GPP) network is normally referred to as an evolved node B (eNodeB), while an access point or radio base station in a fifth generation (5G) 3GPP network is referred to as a next generation node B (gNodeB or gNB). The TRPs 110, 120 are connected 115, 125 to some type of core network 150, such as an evolved packet core network (EPC), or a fronthaul network. The EPC is an example of a network which may comprise wired communication links, such as optical links.

The wireless access network 100 supports at least one radio access technology (RAT) for communicating 111, 121 with the wireless devices 130, 140. It is appreciated that the present disclosure is not limited to any particular type of wireless access network type or standard, nor any particular RAT. The techniques disclosed herein are, however, particularly suitable for use with 3GPP defined wireless access networks that implement multi-TRP transmission, as discussed above.

When one of the wireless devices 130, 140 wishes to connect to the wireless access network, i.e., enter into active mode, a random access procedure is performed. This random access procedure involves the transmission point (TRP) transmitting a synchronization signal, followed by a response to the synchronization signal by the wireless device. Normally, a wireless device detects and responds to one synchronization signal from one transmission point, as indicated in FIG. 1, i.e., the wireless device 140 responds to a transmission from the TRP 110, while the wireless device 130 responds to a transmission from the TRP 120, even if it can hear both TRPs.

For the 5G New Radio (NR), and also for the beyond 5G (B5G) systems, when a wireless device performs the initial random access procedure to associate itself with the network, it starts a so-called cell search procedure. Basically, the wireless device monitors the radio environment to detect one or multiple synchronization signal blocks (SSBs) that are transmitted in a burst by one or multiple TRPs in one or multiple cells.

After decoding at least one SSB, the wireless device requests access to the network by transmitting a physical random access channel (PRACH) signal. A PRACH signal or random access (RA) preamble in a 3GPP defined network is a uniquely identifiable signal based on a Zadoff-Chu sequence. Among some interesting properties of these sequences, is the zero auto-correlation, i.e., that cyclically shifted versions of the sequence (of the same root) are orthogonal to another, provided that each cyclic shift in time domain is greater than the combination of propagation delay and multipath delay spread, as discussed by Gerhard Schreiber and Marcos Tavares in “5G New Radio Physical Random Access Preamble Design,” IEEE 5G World Forum (5GWF), July 2018.

To accommodate the multitude of scenarios envisioned for future networks, the initial access architecture shall be reliable, avoid misdetection as far as possible, and granting access of the wireless devices as fast as possible. Moreover, any transmission during the initial access deserves special attention, as it is necessary to circumvent the propagation effects suffered by transmitted signals along the paths between wireless devices and TRPs, as discussed by Zhipeng Lin et. al. in “SS/PBCH Block Design in 5G New Radio (NR),” IEEE Globecom Workshops (GC Wkshps), December 2018.

To mitigate the propagation effects, for 5G NR, each cell has a restricted set of RA preambles that are presented to the wireless device. These are shifted versions of the Zadoff-Chu sequence for one specific (and different) root per cell. Also, RA preambles shall only be transmitted at specific time-frequency RACH occasions, where the TRP expects to receive the RA requests, as there is no TRP-UE synchronization yet. Nevertheless, the problem with the restricted set approach is that the number of preambles available in each cell is dramatically reduced, thus increasing the probability of collisions. Such an issue is alleviated (but not solved) with the RACH occasions, since the signals with respect to one SSB can be mapped to more than one RACH occasion.

In a multi-TRP scenario, a gNB is connected to multiple spatially distributed TRPs, in order to improve communication conditions for communicating between a wireless device and the access network. Currently, the multi-TRP cluster formation is usually based on the geographic topology of the network. That is, a number of neighboring TRPs, that have overlapping coverage areas to some extent, form static or semi-static coordination clusters. In this case, after RRC setup the wireless device can be associated with a coordination cluster comprising a number of TRPs in its geographic surroundings to exploit multi-TRP transmissions. However, this type of coordination cluster may be sub-optimal compared to the “best” set of TRPs for that wireless device (according to some performance metric) since the cluster formation is not adapted to account for the current radio propagation channels between the wireless device and the set of available TRPs. A practical problem then arises: how to form a UE-centric coordination cluster to serve a certain wireless device in the network without increasing the signaling overhead?

An option advocated herein is to take advantage of the always present RA signals and the RA architecture to perform an early formation of a UE-centric coordination cluster. The present disclosure evolves around this fundamental idea, i.e., to base a dynamic TRP cluster formation on the signals transmitted during the random access procedure. The initially formed clusters may of course be adapted using known techniques, in order to be further optimized.

With reference to FIG. 2, in 5G NR, see, e.g., 3GPP TS 38.321, March 2020, version 16.0.0 and 3GPP TS 38.331, March 2020, version 16.0.0, after receiving the MSG0 (SSB burst), the wireless device, or UE, selects and correctly decodes the beam-SSB with higher reference signal received power (RSRP) and, with that, obtains a first synchronization with the network. There are various forms of radio network temporary identifiers (RNTI) defined by the 3GPP, such as:
SI-RNTI: System Information RNTI
P-RNTI: Paging RNTI
TC-RNTI: Temporary Cell RNTI
C-RNTI: Cell RNTI
MCS-C-RNTI: Modulation Coding Scheme Cell RNTI
CS-RNTI: Configured Scheduling RNTI
TPC-PUCCH-RNTI: Transmit Power Control-PUCCH-RNTI
TPC-PUSCH-RNTI: Transmit Power Control-PUSCH-RNTI
TPC-SRS-RNTI: Transmit Power Control-Sounding Reference Symbols-RNTI
INT-RNTI: Interruption RNTI
SFI-RNTI: Slot Format Indication RNTI
SP-CSI-RNTI: Semi-Persistent CSI RNTI

The wireless device performs two main tasks: it selects a PRACH signal to transmit in the uplink, and it selects a RACH occasion, at which the RA request (PRACH signal) starts to be transmitted. Moreover, the wireless device calculates an identity, the random access radio network temporary identity (RA-RNTI). From a known mapping function each RA-RNTI is associated with a RACH occasion and the RACH occasion with an SSB (and the latter with a beam). Thus, upon receiving the MSG1 (RA request) from the wireless device at a specific RACH occasion, the TRP has conditions to (indirectly) know the selected SSB, the downlink (DL) beam for the subsequent RA procedure steps, and the UE's RA-RNTI.

From a PRACH signal, the network can obtain a quality measurement of the link between the wireless device that has transmitted that signal at least if some level of channel reciprocity between uplink (UL) and downlink (DL) can be assumed. Therefore, in principle, the network acquires implicit channel state information (CSI) of that wireless device directly from the random access transmission by the wireless device. However, it is worth mentioning that, in general, an SSB is transmitted on a wide beam to ease the beam sweep of an SSB burst. It then implies that such an implicit CSI can be very coarse, but this is not an issue for the purpose of radio resource control (RRC) setup since its main goal is to first establish a connection between the wireless device and the network. A beam refinement can be further invoked, if needed, to increase the link quality for data transmission.

In case a wireless device detects multiple SSBs, it may in principle transmit multiple RA requests, i.e., multiple PRACH signals. However, the network cannot know if the multiple received PRACH signals came from the same wireless device. Again, this is not an issue for the purpose of RRC setup, since upon the reception of multiple MSG2s (RA responses (RARs)), the wireless device can eventually select one of them to proceed to MSG3 (RRC setup request). By doing this in a multi-TRP network, the wireless device is implicitly indicating to the network what TRP it should be associated to and then receive the MSG4 (RRC setup).

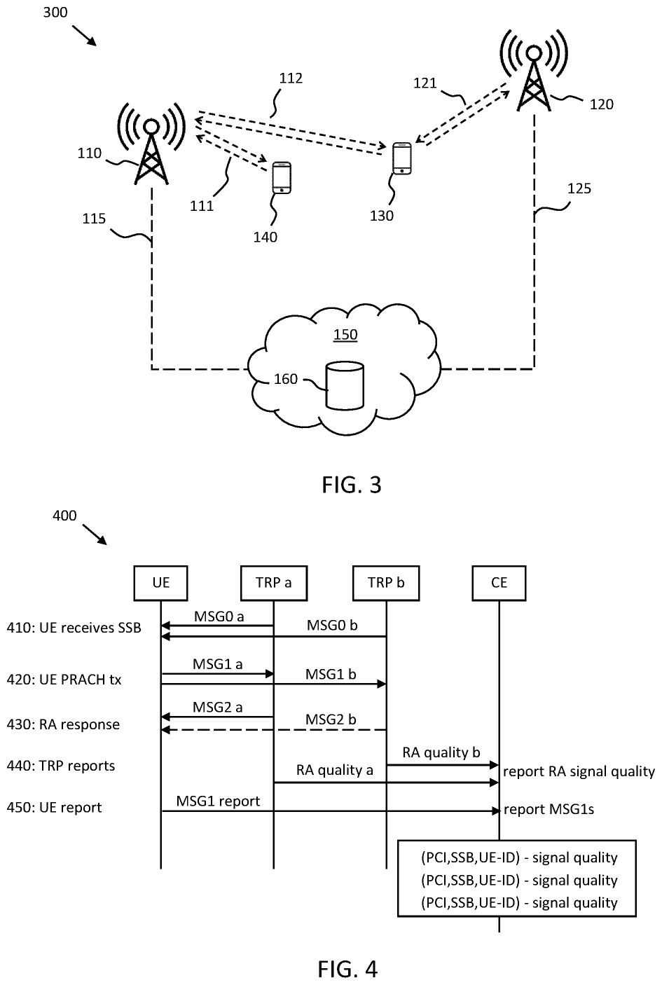

FIG. 3 shows a wireless communication system 300 according to the present disclosure. This wireless communication system is configured for multi-TRP operation, as discussed above. In this case, during the random access procedure, the wireless devices 130, 140 receives and detects more than one synchronization signal transmitted from more than one TRP, and also responds to more than one synchronization signal. In FIG. 3, this is illustrated by the wireless device 130 which receives transmissions from both TRPs, 112, 121, and responds to both transmissions. The TRPs both measure the signal quality of the received random access transmissions from the wireless device 130, and relays the measurement data to a clustering entity 160. However, the clustering entity 160 cannot know which random access transmissions that correspond to the wireless device 130, and which random access transmissions that correspond to the other wireless device 140, or to some further wireless device not shown in FIG. 3. To allow the clustering entity to associate signal quality measurements at a TRP with a wireless device, the wireless devices also report which random access signals that have been transmitted as part of its random access procedure. This report reaches the clustering entity 160, which is then able to generate a dataset which maps signal quality of a wireless device to the different TRPs. Given this dataset, the clustering entity (or some other network node) is able to perform a TRP clustering for use in multi-TRP operation, already as a result of the random access procedure. This way the cluster formation is dynamic, and performed with minimum latency. This also means that the wireless device may be configured with a coordination cluster centered on itself, and based on accurate and up-to-date measurements of signal quality with respect to the surrounding TRPs. This can reduce the need for further refinement of the cluster, thus reducing the latency and the signaling overhead by avoiding further measurements and reporting messages exchange. Also, if a further refinement of the formed coordination cluster is required, less measurements and reporting are expected since the cluster formed during the initial access is already UE-centric. That is, a smaller subset of the overall possible TRPs is expected to be sounded for the purpose of cluster refinement.

The clustering entity 160 may be a central entity arranged in some network node, such as a network node in the core network which is illustrated in FIG. 3. The clustering entity may also be arranged in one of the gNBs. It is furthermore appreciated that the clustering entity can be realized as a distributed function which executes on more than one processing platform in a distributed manner, such as on two or more gNBs and/or at least in part on one or more processing platforms in the ore network 150.

In case the network is able to know that different RA-RNTIs actually point to the same wireless device, it could advantageously obtain a quality measurement vector of that wireless device related to the TRPs that transmitted the corresponding detected SSBs. For instance, consider a wireless device that is associated with multiple RA-RNTIs. Then, upon the reception of an RRC setup request from that wireless device, the network can use the obtained quality measurement vector of that wireless device to already determine a set of TRPs, that would form a TRP cluster, to serve that wireless device after the initial access procedure is completed. This can speed up the cluster formation and create more reliable links-useful for ultra-reliable low-latency communication (URLLC)—and more robust—useful for multi-TRP transmission-characteristics.

Following initial access, the wireless device is configured with a coordination cluster centred in itself, which can minimize the need for further refinement of the cluster, then reducing the latency and the signalling overhead by avoiding further measurements and reporting messages exchange. One may find it extremely important for critical applications, such as sensors and actuators, which only perform small transmissions after random access, whereupon they go off-line again.

Also, if a further refinement of the formed coordination cluster is required, less measurements and reporting are expected since the cluster formed during the initial access is already UE-centric. That is, a smaller subset of the overall possible TRPs is expected to be sounded for the purpose of cluster refinement.

FIG. 4 shows a conceptual example 400 of the methods proposed herein. At step 410, the UE receives SSB transmissions from two (or more) TRPs, here shown as TRP a and TRP b. The UE at step 420 then responds to both SSB transmissions and receives corresponding responses 430. The transmissions from the UE are evaluated in terms of received signal quality, and the result from this evaluation is reported to the clustering entity 440. Finally, the UE also sends 450 a report to the clustering entity allowing the clustering entity to identify which measurements that relate to a given wireless device. There are many different ways in which the UE can identify its transmissions, as will be discussed in more detail below. Some examples of the UE-ID data field comprise RA-RNTI, TC-RNTI, and a combination of RA-RNTI and random access preamble identifier (RAPID).

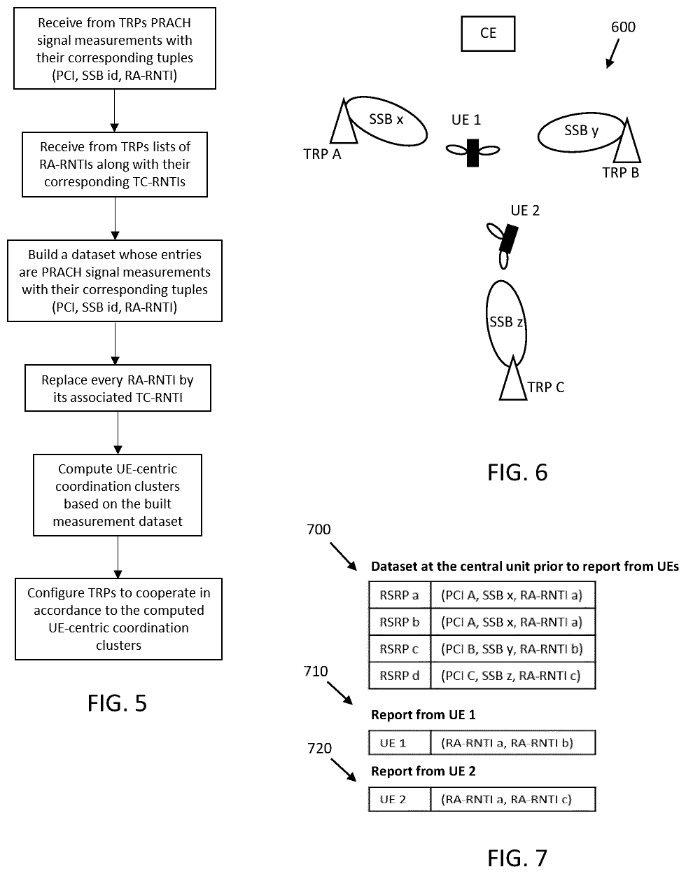

With reference to FIG. 5, the solutions discussed herein comprise a method for determining initial UE-centric coordination clusters during connection establishment of wireless devices for multi-TRP transmissions. To provide an example of the method, the initial coordination clusters can be found by allowing:
a. The network to configure random access procedure to allow setup of coordination clusters;
b. UEs to request random access by sending RA preambles related to different detected synchronization signals from one or multiple TRPs associated with one or multiple physical cell identities (PCIs);
C. TRPs to measure the signal quality of received RA preambles, each being associated with its corresponding RA-RNTI and SSB identifier;
d. TRPs to share those signal quality measurements, each with its RA-RNTI and SSB identifier, with some upper-level/clustering entity that communicates with surrounding TRPs;
e. UEs to report the RA-RNTIs of their transmitted RA preambles in RRC setup request messages;
f. TRPs to share the list of reported RA-RNTIs of UEs that requested RRC setup with the clustering entity, as a means of consolidating multiple measurements related to the same UE, allowing to translate multiple RA-RNTIs related to a UE into its UE identity;
g. The clustering entity to associate each shared signal quality measurement with a tuple (PCI, SSB identifier, TC-RNTI), and to store such tuples in a dataset;
h. The clustering entity or some other cluster function node in the network, to compute a UE-centric coordination cluster for each UE requesting random access based on the built dataset;
i. UEs to establish connection with the network and perform data transmission/reception with one or multiple TRPs belonging to its coordination cluster.

As an example, the RA configuration conveyed by SSBs can have a specific flag that indicates to the wireless devices that coordination cluster formation is to be carried out or not during RA. The network controller or controllers can also configure TRPs to follow the coordination cluster formation during RA.

Upon detection of a plurality of synchronization signals from multiple TRPs belonging to one or multiple cells, an idle/inactive wireless device can request random access by sending preambles associated with synchronization signals related to one or multiple cell identifiers, i.e., PCIs. In turn, the TRPs receive the transmitted RA preambles in the corresponding RACH occasions and measure the signal quality of each received RA preamble. A TRP associates each measured signal quality with a tuple (PCI, SSB identifier, RA-RNTI) and shares those measurements with an upper-level/clustering entity, assuming that each TRP has a fast enough backhaul link to the clustering entity.

As another example, the definition of PRACH signal quality depends on the level of channel reciprocity assumed and the capability of the receiver. Thus, it can be as simple as the RSRP measured at the reception of a PRACH signal but can also be based on angular/delay information, for instance. Several examples of signal quality metric will be discussed in more detail below. The signal quality metric may be associated with multi-antenna operation or single-antenna operation and may comprise metrics related to both robustness and availability as well as spectral efficiency and data throughput.

As an example, although each received RA preamble has an RA-RNTI, at this stage the network is not aware that different RA-RNTIs may be associated with a single wireless device. That is, the TRPs can respond to each RA request with an RAR within the corresponding RAR window, even though some of them may be for the same wireless device. Nevertheless, upon reception of one or multiple RARs, a wireless device requests an RRC setup based on one of the received RARs (e.g., the one related to the beam-SSB received with highest RSRP). In the RRC setup request message, that wireless device attaches the RA-RNTIs of the RA preambles it has previously transmitted. Upon reception of a given RRC setup request, the corresponding TRP can then share the list of reported RA-RNTIs with the clustering entity, such a list being associated with the I. This case should be carried out within the corresponding system frame as a RA-RNTI is defined in a system frame basis. In this context, it is noted that it is not catastrophic if a wireless device is erroneously associated with a random access transmission, as long as it does not happen too often.

As another example, instead of reporting RA-RNTIs in a RRC setup request message, the wireless device responds to multiple RARs that it can detect, either all or a subset of them given some selection criteria. This way, the network can directly know that multiple RRC setup requests are in fact associated with the same wireless device.

The network can indicate to idle/inactive wireless devices that multi-TRP transmissions is possible, so those wireless devices can advantageously request random access by sending different RA preambles as aforementioned. In turn, a RAR can also indicate the wireless device that it should report up to a number of RA-RNTIs, which is pre-configured by the network. The wireless device may also sort the list of RA-RNTIs to be reported by signal quality strength (e.g., RSRP), or any predetermined order. Upon indication that multi-TRP transmission is possible, the wireless device can detect multiple SSB bursts as a means to find SSBs from different TRPs and, eventually, request random access through PRACH signals related to SSBs of different PCIs.

As another example, the wireless device can report a list of RA-RNTIs related only to the RARs it could detect in DL, then avoiding the report of a RA-RNTI related to either a PRACH signal not received by the corresponding TRP or a RAR not received by that wireless device. Moreover, the number of RA-RNTIs to be reported maybe limited in accordance with some criteria, which directly or indirectly affects the number of TRPs within the coordination cluster for that wireless device.

The clustering entity may consolidate different RA-RNTIs related to the same wireless device identity, so that the tuples (PCI, SSB identifier, RA-RNTI) of a signal quality measurements are translated into a tuple (PCI, SSB identifier, wireless device identity). That is, each signal quality measurement is then associated with a wireless device with a particular identity that previously requested random access after detecting a particular SSB from a TRP with a particular PCI. All the signal quality measurements and their associated tuples comprise a measurement dataset with relevant information for determining UE-centric coordination clusters for multi-TRP transmissions. In case of RACH preamble collision, the same RA-RNTI may be associated with multiple wireless devices, which can lead to a measurement data sample associated with multiple (PCI, SSB identifier, wireless device identity). However, the clustering entity should be able to deal with such cases by, for instance, discarding such data samples or following some criteria to keep one of the multiple samples to associate it with the corresponding tuple. Of course, if the C-RNTI is available (e.g., when transmitted at RRC setup request), it can be used instead of the wireless device identity.

The clustering entity can compute a UE-centric coordination cluster for each of the wireless devices requesting RRC setup based on the measurement dataset, also considering other available network/UE measurements, and aiming at optimizing metrics such as sum rate, TRP load, etc. The availability of early coordination clusters already during RRC setup can avoid further RRC measurements and reporting to eventually determining coordination clusters for multi-TRP transmissions.

As an example, the sharing of such signal quality measurements and lists of reported RA-RNTIs can be carried out in a distributed fashion, i.e., without the use of a clustering entity, by assuming fast backhaul links among TRPs. A TRP can disseminate at least part of its local pieces of information to the other TRPs so that every TRP ends up having part of/all the information needed to at least partially compute the coordination cluster of the wireless device requesting RRC setup.

It is appreciated that the use of RA-RNTI in identifying a UE transmitting a given random access signal may lead to ambiguity, and thus potentially also to the formation of sub-optimal clusters. Such sub-optimal clusters can always be refined at a later stage, so this is not a critical issue, although it is of course preferred that the initial clusters are as well formed as possible given the communication scenario and environment parameters.

A tuple defined as (PCI, SSB identifier, RA-RNTI) maps the measurement of the received preamble related to that SSB identifier from the TRP of that PCI and to the RA-RNTI that is calculated based on the RACH occasion at which the random access preamble was transmitted. However, the RA-RNTI does not depend on any preamble identifier. When multiple UEs transmit different preambles in the same RACH occasion, there is no preamble collision since preambles are usually orthogonal to one another (due to the Zadoff-Chu sequences' characteristics), allowing separation of multiple received signals. However, the resulting measurements will be associated with the same RA-RNTI since the preambles were transmitted in the same RACH occasion. Therefore, the network may not be able to map some of the measurements onto the correct UE-resulting in undesired ambiguity.

As an example, consider the scenario 600 illustrated in FIG. 6. FIG. 6 depicts a typical multi-TRP scenario where three TRPs cover an area with two multi-panel UEs: UE1 and UE2. The network implements the proposed random access procedure to achieve an initial coordination cluster formation.

In this example 600, UE 1 detects SSBs from TRP A and TRP B, while UE 2 detects SSBs from TRP A and C. Besides, UE 1 and 2 detects the same SSB from TRP A, say SSB x, and they choose the same RACH occasion to transmit different preambles to TRP A. No preamble collision occurs in this case since the preambles from the two UEs are sufficiently orthogonal. Thus, TRP A (associated with PCI A) measures two different signals, which results in two signal quality measurement samples, say RSRP a and RSRP b, where RSRP demotes reference signal received power. These two measurement samples are then associated with the same RA-RNTI because they are related to the same RACH occasion. TRP B (associated with PCI B) also measures RSRP c and calculates RA-RNTI b, while TRP C (associated with PCI C) measures RSRP d and calculates RA-RNTI c. The measurement samples are relayed to the clustering entity, in this case a central unit CE, which stores the samples in a dataset 700 as illustrated in FIG. 7. On the UE side, during the RRC setup request, UE 1 reports the list 710 (RA-RNTI a, RA-RNTI b), while UE 2 reports the list 720 (RA-RNTI a, RA-RNTI c) to the clustering entity, as also illustrated in FIG. 7

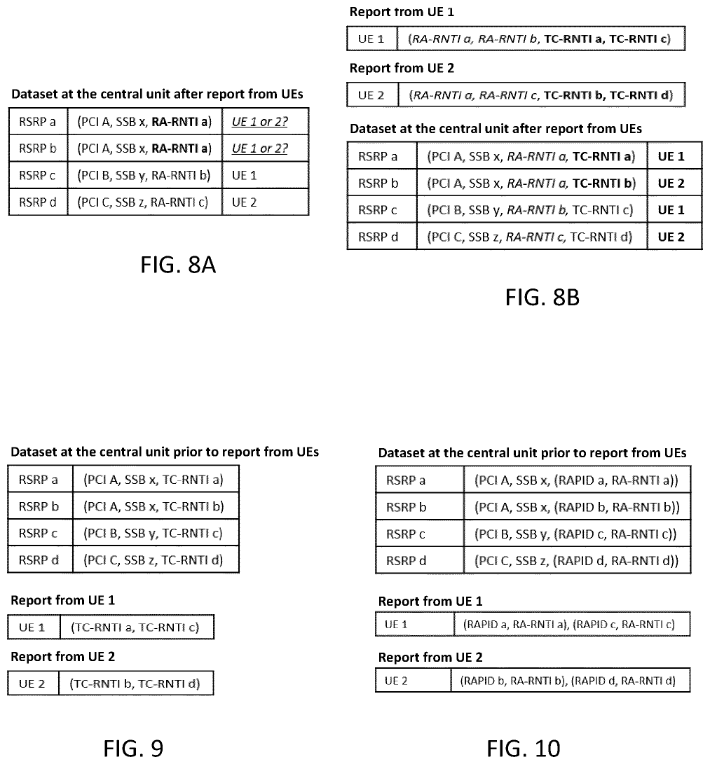

A potential sub-optimality is now noted. The central unit cannot map RSRP samples to the correct UE identifier upon reception of the reports from the UEs. FIG. 8A illustrates the situation: after receiving the list of RA-RNTIs from UE 1 and UE 2, the central unit obtains RA-RNTI a from both UEs, and it cannot know if RSRP a corresponds to UE 1 or to UE 2. The same applies to RSRP b. Note that there is no ambiguity regarding RSRP samples c and d since RA-RNTI b and c appear only once in the reported lists.

A TC-RNTI is calculated at the TRP (or in the core network) after the reception of a preamble and eventually transmitted in MSG 2 (RAR). Thus, a RSRP measurement sample can be directly associated with a TC-RNTI on the TRP side. In the example above, RSRP a and b have the same RA-RNTI, but they are associated with different TC-RNTIs because there is no preamble collision. The remaining RSRP samples also have different TC-RNTIs. Since each RAR delivers a TC-RNTI to the UE, TC-RNTIs are also available on the UE side. Then, the TC-RNTI can in principle be included in the dataset at the central unit, as well as in the message reported by the UEs.

For instance, the dataset at the central unit and the UE reports shown in FIG. 8A could then be extended to include TC-RNTIs, as shown in FIG. 8B, where the ambiguity is now resolved. In this example, clearly each RSRP measurement sample is related to a different TC-RNTI.

Also, it is understood that the RA-RNTI does not play a significant role in the presence of the TC-RNTI. Therefore, the RA-RNTI can be omitted in the tuple associated to a signal quality measurement on the TRP side. It can also be replaced by TC-RNTI in the message to be reported by the UE during RRC setup request. In other words, the UE can report only its list of TC-RNTIs. FIG. 9 shows the resulting dataset and report structure that include only TC-RNTI.

One important remark is that the UE should detect all the RARs transmitted by the TRP to obtain its list of TC-RNTIs. However, the detection of an RAR by the UE can indicate that its beam pair link with the corresponding TRP is good (above a certain threshold) in both directions. This can be a relevant input to the cluster formation algorithm. Alternatively, the UE (or pre-determined by the network) could simply decide to detect less RARs, e.g., only the first detectable ones, so that UE's battery and resources are saved, at the cost of losing some signal quality measurements already available at the central unit.

As already mentioned, random access preambles are in principle orthogonal one to another; while a RACH occasion can be associated with multiple preambles, being a (possible) source for the ambiguity discussed above. Upon decoding a beam from the TRP during the initial beam sweep, the EU picks a preamble (i.e., a Zadoff-Chu sequence) from a predefined list. Each preamble is referenced with a preamble identifier, the random access preamble identifier (RAPID). That preamble is sent in MSG1.

After detecting a MSG1, the TRP has conditions to determine the RAPID based on the sent preamble. Which would be known at both network ends. Note that a similar approach is embedded in the RA-RNTI knowledge.

As such, another possibility to resolve any potential ambiguity, as an alternative to the use of TC-RNTI, is to attach the RAPID together with the RA-RNTI at MSG3.

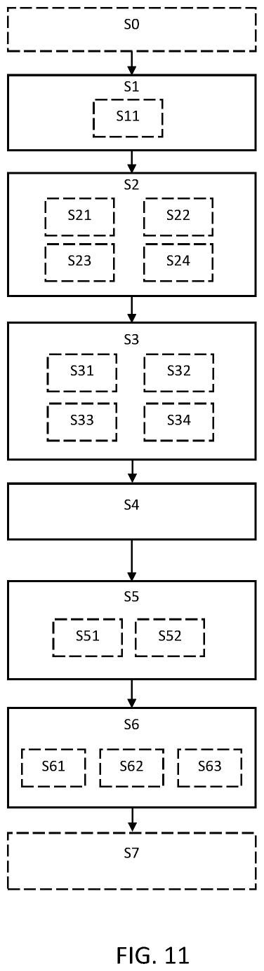

FIG. 11 is a flow chart which summarizes the methods discussed above. With reference also to FIG. 3, the method illustrates a method for performing initial access by a wireless device 130 in a wireless communication system 300 The communication system comprises two or more TRPs 110, 120 connected to a clustering entity 160. The connection between TRPs and the clustering entity may be a wireless connection, such as a microwave backhaul point to point link, or some type of fronthaul connection. The connection between the TRPs and the clustering entity may also be a wired connection, such as part of a core network.

Optionally, the method comprises initially broadcasting SO a multi-TRP transmission indication from the TRPs. This tells the wireless devices in the network that the method can be performed. This step is, however, entirely optional. The method comprises receiving S1 synchronization signals by the wireless device 130, where each synchronization signal originates from a respective TRP 110, 120. The synchronization signals may, e.g., be in the form of SSB transmissions S11 which occur with some periodicity. The SSB transmissions implemented as part of the random access procedure in wireless access networks like 5G can be re-used for the purposes discussed herein.

The method also comprises transmitting S2 respective random access signals from the wireless device 130 to the TRPs 110, 120 in response to the received synchronization signals, where each random access signal is associated with a random access signal identification. Thus, the wireless device responds to synchronization signals received from more than one TRP. The wireless device may respond to two or more synchronization signals in this manner. Each such response is associated with a random access signal identification, which allows a third party to identify random access signals that originate from a given wireless device, at least with some probability. Notably, the random access signal identification may in some cases not uniquely identify the source of a random access signal. For instance, if the random access signal identifications are determined based on the SSB transmission that is responded to, then two or more wireless devices responding to the same synchronization signal transmission will be associated with the same random access signal identification. Such collisions can be resolved at a later stage or will result in some sub-optimality in the cluster formation, which can be optimized at a later stage. A wireless device may, for instance, be identified by its cell radio network temporary identifier (C-RNTI), although other means for identifying a wireless device of course also exist.

Optionally, the random access signals S21 comprise random access preamble signals transmitted over a Physical Random Access Channel (PRACH), in a 3GPP defined wireless communication system. The random access signal identification S22 may comprise a random access radio network temporary identity, RA-RNTI. However, as discussed above in connection to FIGS. 6-10, further improvements can be obtained if the random access signal identification comprises a temporary cell radio network temporary identity (TC-RNTI) S23, or a combination of RA-RNTI and a Random Access Preamble Identifier (RAPID) S24.

The method further comprises measuring S3 respective signal qualities of the random access signals received at the TRPs 110, 120, and associating each signal quality measurement with a respective random access signal identification.

Thus, the measurements of signal quality are mapped to the random access signals via the random access signal identifications. This means that a mechanism for associating wireless devices with signal quality measurements made at a TRP is established. It is appreciated that different types of signal quality metrics can be applied in this context, and also that combinations of different signal quality metrics can be used with advantage. For instance, signal quality measurement may comprise any (combination of) a received signal strength S31, a binary indication of successful reception S32, a measure of radio propagation channel delay or angle S33, and/or a measure of radio propagation channel dispersion and/or angle of arrival information S34.

It is appreciated that the cluster formation may be based on a combined metric comprising constituent parts such as if the wireless device is able to communicate with a given TRP, how stable this communication is, what the expected signal-to-noise ratio and or signal to interference and noise ratio is, what the expected throughput is, and if the phase and delay distributions of the radio propagation channel are suitable for advanced antenna array operation.

Now, by communicating S4 the measured signal qualities with corresponding random access signal identifications from the TRPs to the clustering entity 160, and communicating S5 data indicative of random access signal identifications associated with the plurality of random access signals transmitted by the wireless device 130, from the wireless device 130 to the clustering entity 160, it becomes possible to construct S6 a dataset at the clustering entity 160 which comprises measured signal qualities with corresponding TRPs 110, 120 and wireless devices 130, based on the random access signal identifications received from the TRPs and on matching random access signal identifications received from the wireless device 130. This dataset is now configured to support cluster formation of the TRPs for communicating with a wireless device using multi-TRP operation. Basically, the dataset will indicate the channel quality between a given wireless device and a set of TRPs. Consequently, the dataset can be used as input to a cluster formation algorithm that generates TRP clusters in dependence of the current radio channel propagation conditions. The dataset may, for instance, comprise tuples of Physical Cell ID (PCI) SSB identifier, and wireless device ID with corresponding signal quality measurement S63.

According to some aspects, the method comprises transmitting S51 a radio resource control (RRC) setup request from the wireless device, corresponding to at least two of the transmitted random access signals. This way the network can obtain information about which random access signals that were transmitted by the wireless device, since the wireless device would only transmit RRC setup requests for synchronization signals that it detected. The method may also comprise communicating S52 data indicative of random access signal identifications associated with random access signals transmitted by the wireless device 130, from the wireless device 130 to the clustering entity 160, as part of an RRC setup request message.

The constructing of the dataset optionally comprises identifying S61 a subset of random access signal identifications received from the TRPs as belonging to a single wireless device, based on the data indicative of random access signal identifications associated with random access signals transmitted by the wireless device 130. Thus, measurements of signal quality are linked to transmissions by a wireless device via the random access signal identifications. For instance, the constructing may comprise identifying S62 a set of RA-RNTI which is associated with the wireless device 130.

The method may also comprise determining S7 a cluster formation of TRPs for serving the wireless device 130, based on the dataset constructed at the clustering entity, although it is appreciated that this part of the method can also be performed at some other entity in the network, such as a scheduling function node, or a multi-TRP coordination node.

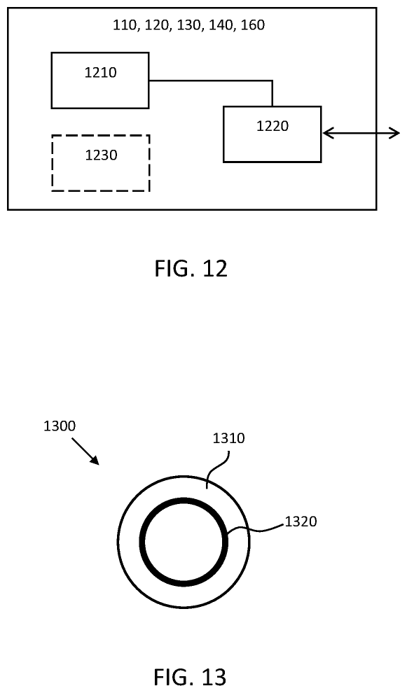

FIG. 12 schematically illustrates, in terms of a number of functional units, the general components of a network node according to embodiments of the discussions herein. Processing circuitry 1210 is provided using any combination of one or more of a suitable central processing unit CPU, multiprocessor, microcontroller, digital signal processor DSP, etc., capable of executing software instructions stored in a computer program product, e.g., in the form of a storage medium 1230. The processing circuitry 1210 may further be provided as at least one application specific integrated circuit ASIC, or field programmable gate array FPGA.

Particularly, the processing circuitry 1210 is configured to cause the device 110, 50 to perform a set of operations, or steps, such as the methods discussed in connection to FIG. 4 and the discussions above. For example, the storage medium 1230 may store the set of operations, and the processing circuitry 1210 may be configured to retrieve the set of operations from the storage medium 1230 to cause the device to perform the set of operations. The set of operations may be provided as a set of executable instructions. Thus, the processing circuitry 1210 is thereby arranged to execute methods as herein disclosed. In other words, there is shown a network node comprising processing circuitry 1210, a network interface 1320 coupled to the processing circuitry 1210 and a memory 1230 coupled to the processing circuitry 1210, wherein the memory comprises machine readable computer program instructions that, when executed by the processing circuitry, causes the network node to transmit and to receive a radio frequency waveform.

The storage medium 1230 may also comprise persistent storage, which, for example, can be any single one or combination of magnetic memory, optical memory, solid state memory or even remotely mounted memory.

The device may further comprise an interface 1320 for communications with at least one external device. As such the interface 1320 may comprise one or more transmitters and receivers, comprising analogue and digital components and a suitable number of ports for wireline or wireless communication.

The processing circuitry 1210 controls the general operation of the device e.g., by sending data and control signals to the interface 1320 and the storage medium 1230, by receiving data and reports from the interface 1320, and by retrieving data and instructions from the storage medium 1230. Other components, as well as the related functionality, of the control node are omitted in order not to obscure the concepts presented herein.

It is appreciated that the herein disclosed methods can be realized as devices. In particular, there is disclosed herein a wireless device 130 arranged to perform initial access in a wireless communication system 300, where the communication system comprises two or more transmission points, TRP, 110, 120 connected to a clustering entity 160, the wireless device comprising processing circuitry 1210 configured to
receive synchronization signals, where each synchronization signal originates from a respective TRP 110, 120, and
transmit respective random access signals to the TRPs 110, 120 in response to the received synchronization signals, where each random access signal is associated with a random access signal identification.

There is also disclosed herein a transmission point, TRP, 110 arranged to perform initial access in a wireless communication system 300, where the communication system comprises at least one other TRP 120, where both TRPs 110, 120 are connected to a clustering entity 160, the TRP comprising processing circuitry 1210 configured to
transmit a synchronization signal to the wireless device 130,
receive a respective random access signal from the wireless device 130 in response to the transmitted synchronization signal, where the random access signal is associated with a random access signal identification,
measure a respective signal quality of the random access signal received at the TRP 110, and associate the signal quality measurement with a respective random access signal identification,
communicate the measured signal quality with the corresponding random access signal identification to the clustering entity 160.

There is furthermore disclosed herein a clustering entity network node 160 in a wireless communication system 300, where the communication system comprises two or more transmission points, TRP, 110, 120 and at least one wireless device 130, where the clustering entity network node 160 is arranged to support cluster formation of the at least two transmission points, TRPs, 110, 120 for communicating with the wireless device using multi-TRP operation, the clustering entity comprising processing circuitry 1210 configured to
receive measured signal qualities associated with random access signals transmitted by the wireless device 130 to the TRPs, with corresponding random access signal identifications, from the TRPs,
receive data indicative of random access signal identifications associated with a plurality of random access signals transmitted by the wireless device 130, from the wireless device 130, and
construct a dataset comprising measured signal qualities with corresponding TRPs 110, 120 and wireless devices 130, based on the random access signal identifications received from the TRPs and on matching random access signal identifications received from the wireless device 130,
where the dataset is configured to support cluster formation of the TRPs for communicating with a wireless device using multi-TRP operation.

FIG. 13 illustrates a computer readable medium 1310 carrying a computer program comprising program code means 1320 for performing the methods illustrated in, e.g., FIG. 4, when said program product is run on a computer. The computer readable medium and the code means may together form a computer program product 1300.

1-21. (canceled)

22. A method for performing initial access by a wireless device in a wireless communication system, where the communication system comprises two or more transmission points, TRP, connected to a clustering entity, the method comprising:
receiving synchronization signals by the wireless device, where each synchronization signal originates from a respective TRP,
transmitting respective random access signals from the wireless device to the TRPs in response to the received synchronization signals, where each random access signal is associated with a random access signal identification,
measuring respective signal qualities of the random access signals received at the TRPs, and associating each signal quality measurement with a respective random access signal identification,
communicating the measured signal qualities with corresponding random access signal identifications from the TRPs to the clustering entity,
communicating data indicative of random access signal identifications associated with the plurality of random access signals transmitted by the wireless device, from the wireless device to the clustering entity,
constructing a dataset at the clustering entity comprising measured signal qualities with corresponding TRPs and wireless devices, based on the random access signal identifications received from the TRPs and on matching random access signal identifications received from the wireless device,
where the dataset is configured to support cluster formation of the TRPs for communicating with a wireless device using multi-TRP operation.

23. The method according to claim 22, further comprising determining a cluster formation of TRPs for serving the wireless device, based on the dataset constructed at the clustering entity.

24. The method according to claim 22, wherein the synchronization signals comprise synchronization signal blocks, SSB, in a third generation partnership, 3GPP, defined wireless communication system.

25. The method according to claim 22, wherein the random access signals comprise random access preamble signals transmitted over a Physical Random Access Channel, PRACH, in a 3GPP defined wireless communication system.

26. The method according to claim 22, wherein the random access signal identification comprises a random access radio network temporary identity, RA-RNTI.

27. The method according to claim 22, wherein the random access signal identification comprises a temporary cell radio network temporary identity, TC-RNTI.

28. The method according to claim 22, wherein the random access signal identification comprises a RA-RNTI and a Random Access Preamble Identifier, RAPID.

29. The method according to claim 22, where a signal quality measurement comprises a received signal strength.

30. The method according to claim 22, where a signal quality measurement comprises a binary indication of successful reception.

31. The method according to claim 22, where a signal quality measurement comprises a measure of radio propagation channel delay or angle.

32. The method according to claim 22, where a signal quality measurement comprises a measure of radio propagation channel dispersion and/or angle of arrival information.

33. The method according to claim 22, comprising transmitting a radio resource control, RRC, setup request from the wireless device, corresponding to at least two of the transmitted random access signals.

34. The method according to claim 22, comprising communicating data indicative of random access signal identifications associated with random access signals transmitted by the wireless device, from the wireless device to the clustering entity, as part of an RRC setup request message.

35. The method according to claim 22, where the constructing comprises identifying a subset of random access signal identifications received from the TRPs as belonging to a single wireless device, based on the data indicative of random access signal identifications associated with random access signals transmitted by the wireless device.

36. The method according to claim 26, where the constructing comprises identifying a set of RA-RNTI which is associated with the wireless device.

37. The method according to claim 22, where the dataset comprises tuples of physical cell ID, PCI, SSB identifier, and wireless device ID with corresponding signal quality measurement.

38. The method according to claim 22, where a wireless device is identified by its cell radio network temporary identifier, C-RNTI and comprising initially broadcasting a multi-TRP transmission indication from the TRPs.

39. A wireless device arranged to perform initial access in a wireless communication system, where the communication system comprises two or more transmission points, TRP, connected to a clustering entity, the wireless device comprising processing circuitry configured to:
receive synchronization signals, where each synchronization signal originates from a respective TRP, and
transmit respective random access signals to the TRPs in response to the received synchronization signals, where each random access signal is associated with a random access signal identification.

40. A transmission point, TRP, arranged to perform initial access in a wireless communication system, where the communication system comprises at least one other TRP, where both TRPs are connected to a clustering entity, the TRP comprising processing circuitry configured to:
transmit a synchronization signal to the wireless device,
receive a respective random access signal from the wireless device in response to the transmitted synchronization signal, where the random access signal is associated with a random access signal identification,
measure a respective signal quality of the random access signal received at the TRP, and associate the signal quality measurement with a respective random access signal identification,
communicate the measured signal quality with the corresponding random access signal identification to the clustering entity.

41. A clustering entity network node in a wireless communication system, where the communication system comprises two or more transmission points, TRP, and at least one wireless device, where the clustering entity network node is arranged to support cluster formation of the at least two transmission points, TRPs, for communicating with the wireless device using multi-TRP operation, the clustering entity comprising processing circuitry configured to:
receive measured signal qualities associated with random access signals transmitted by the wireless device to the TRPs, with corresponding random access signal identifications, from the TRPs,
receive data indicative of random access signal identifications associated with a plurality of random access signals transmitted by the wireless device, from the wireless device, and
construct a dataset comprising measured signal qualities with corresponding TRPs and wireless devices, based on the random access signal identifications received from the TRPs and on matching random access signal identifications received from the wireless device,
where the dataset is configured to support cluster formation of the TRPs for communicating with a wireless device using multi-TRP operation.
